(19) United States
(12) Patent Application Publication
(10) Pub. No.: US 2020/0241393 A1
(43) Pub. Date: Jul. 30, 2020

(54) IMAGE-CAPTURING APPARATUS

(71) Applicant: SONY CORPORATION, TOKYO (JP)

(72) Inventor: KENJI HIMENO, KANAGAWA (JP)

(21) Appl. No.: 16/489,768

(22) PCT Filed: Feb. 2, 2018
(86) PCT No.: PCT/JP2018/003577

§ 371 Date: Aug. 29, 2019

(30) Foreign Application Priority Data
Mar. 28, 2017 (JP) 2017-062520

(51) Int. Cl. G03B 17/04; G03B 17/18; H04N 5/225

(52) U.S. Cl. CPC G03B 17/04; H04N 5/2251; G03B 17/18

(57) ABSTRACT

An image-capturing apparatus according to an embodiment of the present technology includes a main body, a display unit, a hinge mechanism, a detector, and a controller. The main body includes an imaging optical system. The display unit displays an image. The hinge mechanism couples the display unit to the main body and supports the display unit rotatably about a first axis, a second axis, and a third axis with respect to the main body, the second axis being orthogonal to the first axis, the third axis being orthogonal to the first and second axes. The detector detects a pose of the display unit. The controller controls a display of an image on the display unit according to an output from the detector.

### TECHNICAL FIELD

The present technology relates to an image-capturing apparatus including a display unit rotatably mounted on a main body of the image-capturing apparatus.

### BACKGROUND ART

Conventionally, regarding an image-capturing apparatus such as a handy camcorder, a configuration in which a display unit such as a liquid crystal display is rotatably supported by a main body of an image-capturing apparatus through a dual-axis hinge mechanism, is known (for example, Patent Literature 1).

### CITATION LIST

### Patent Literature

Patent Literature 1: Japanese Patent Application Laid-open No. 2005-210677

### DISCLOSURE OF INVENTION

### Technical Problem

In a location for, for example, shooting a film, it is often the case that a single image-capturing apparatus is used by more than one person. In this case, a photographer may check a display screen of a display unit from a lateral side of a main body of the image-capturing apparatus.

However, it is not possible to turn a display surface of the image-capturing apparatus disclosed in Patent Literature 1 to a lateral side of a main body of the image-capturing apparatus. Thus, it is difficult for a photographer to check the display surface from the lateral side of the main body of the image-capturing apparatus. Accordingly, in recent years, the range of motion of a display unit mounted on a main body of an image-capturing apparatus has been desired to be expanded.

Further, the image-capturing apparatus disclosed in Patent Literature 1 has a configuration for the image-capturing apparatus being manipulated by a photographer from an optically axial rear direction. Thus, it is not possible to display an image suitable for a photographer in a location except for the optically axial rear direction.

In view of the circumstances as described above, it is an object of the present technology to provide an image-capturing apparatus that includes a display unit being mounted on a main body of the image-capturing apparatus and having a wide range of motion, and makes it possible to display, on the display unit, an image suitable for a respective pose of the display unit.

### Solution to Problem

In order to achieve the object described above, an image-capturing apparatus according to an embodiment of the present technology includes a main body, a display unit, a hinge mechanism, a detector, and a controller.

The main body includes an imaging optical system.

The display unit displays an image.

The hinge mechanism couples the display unit to the main body and supports the display unit rotatably about a first axis, a second axis, and a third axis with respect to the main body, the second axis being orthogonal to the first axis, the third axis being orthogonal to the first and second axes.

The detector detects a pose of the display unit.

The controller controls a display of an image on the display unit according to an output from the detector.

This configuration permits a photographer to check an image displayed on the display unit not only from an optically axial rear direction but also from all of the directions. Further, the image-capturing apparatus switches, according to the change of a pose of the display unit, the image displayed on the display unit to an image corresponding to a respective pose of the display unit.

Accordingly, the present technology makes it possible to provide an image-capturing apparatus that includes a display unit having a wide range of motion, and makes it possible to display, on the display unit, an image suitable for a respective pose of the display unit.

The hinge mechanism may include

a first rotational shaft parallel to the first axis,

a second rotational shaft orthogonal to the first axis,

a third rotational shaft orthogonal to the second axis,

a first coupling portion supported by the main body through the first rotational shaft, and

a second coupling portion supported by the first coupling portion through the second rotational shaft, the second coupling portion supporting the display unit through the third rotational shaft.

The first coupling portion may rotate 180 degrees about the first rotational shaft with respect to the main body.

The second rotational shaft may be skew to the first rotational shaft.

The second coupling portion may rotate 270 degrees about the second rotational shaft with respect to the first coupling portion.

This results in being able to accommodate the display screen of the display unit in a state of being oriented toward a lateral side of the main body.

The display unit may rotate 180 degrees about the third rotational shaft with respect to the second coupling portion.

This results in being able to invert the orientation of the display screen of the display unit.

The first coupling portion may be supported by the main body rotatably in an optical axis direction of the imaging optical system, and

the second coupling portion may be supported by the first hinge rotatably about the optical axis.

The first coupling portion may rotate about the first rotational shaft with a torque not less than a first torque value,

the second coupling portion may rotate about the second rotational shaft with a torque not less than a second torque value that is less than the first torque value, and

the display unit may rotate about the third rotational shaft with a torque not less than a third torque value that is less than the second torque value.

This results in preventing an erroneous manipulation upon rotating the display unit, and in improving handling capability of the image-capturing apparatus.

The detector may be provided in the hinge mechanism.

This results in being able to detect each pose that may be made by the display unit.

The controller may include

a pose determination unit that determines a pose of the display unit relative to the main body according to an output from the detector, and

an image switcher that switches, according to a result of the determination performed by the pose determination unit, an image displayed on the display unit from a first image captured by the imaging optical system to a second image different from the first image.

This results in being able to switch, according to the change of a pose of the display unit, the image displayed on the display screen to an image suitable for a respective pose of the display unit.

The pose determination unit may detect, as a first longitudinal pose of the display unit, a state in which the first rotational shaft, the second rotational shaft, and the third rotational shaft are respectively parallel to the first axis, the second axis, and the third axis, and

the image switcher may switch from the first image to a two-screen image when the display unit is in the first longitudinal pose.

The pose determination unit may detect, as a second longitudinal pose of the display unit, a state in which the second rotational shaft and the third rotational shaft are each inclined at a specified angle toward the imaging optical system from a state in which the second rotational shaft and the third rotational shaft are respectively parallel to the second axis and the third axis, and

the image switcher may switch from the first image to a two-screen image when the display unit is in the second longitudinal pose.

An external display unit may be further included, the external display unit including a manipulation unit being capable of manipulating an image captured by the imaging optical system, the external display unit displaying the image.

This results in a plurality of photographers more easily proceeding with different tasks at the same time using a single image-capturing apparatus.

### Advantageous Effects of Invention

As described above, the present technology makes it possible to provide an image-capturing apparatus that includes a display unit being mounted on a main body of the image-capturing apparatus and having a wide range of motion, and makes it possible to display, on the display unit, an image suitable for a respective pose of the display unit. Note that the effects described above are not necessarily limitative, and any of the effects described in the present disclosure or any of the other effects that can be understood from the present disclosure, may be provided in addition to the effects described above or instead of the effects described above.

### BRIEF DESCRIPTION OF DRAWINGS

FIG. 1 illustrates a configuration example of an image-capturing apparatus according to a first embodiment of the present technology.

FIG. 2 is an enlarged view illustrating a portion around a hinge mechanism of the image-capturing apparatus.

FIG. 3 is an enlarged front view of the hinge mechanism.

FIG. 4 is an enlarged side view of the hinge mechanism.

FIG. 5 illustrates a rotational range of a coupling portion constituting the hinge mechanism.

FIG. 6 illustrates a rotational range of a coupling portion constituting the hinge mechanism.

FIG. 7 illustrates a rotational range of a display unit of the image-capturing apparatus.

FIG. 8 is a block diagram of the configuration example of the image-capturing apparatus.

FIG. 9 illustrates an operation of the display unit in the image-capturing apparatus.

FIG. 10 illustrates an operation of the display unit in the image-capturing apparatus.

FIG. 11 illustrates an operation of the display unit in the image-capturing apparatus.

FIG. 12 illustrates a pose from among poses that may be made by the display unit.

FIG. 13 illustrates a pose from among poses that may be made by the display unit.

FIG. 14 illustrates a pose from among poses that may be made by the display unit.

FIG. 15 illustrates a variation of an image displayed on a display screen of the display unit.

FIG. 16 illustrates a variation of an image displayed on the display screen of the display unit.

FIG. 17 illustrates a variation of an image displayed on the display screen of the display unit.

FIG. 18 illustrates a variation of an image displayed on the display screen of the display unit.

FIG. 19 illustrates a variation of an image displayed on the display screen of the display unit.

FIG. 20 illustrates a configuration example of an image-capturing apparatus according to a second embodiment of the present technology.

FIG. 21 is a block diagram of the configuration example of the image-capturing apparatus.

FIG. 22 illustrates a configuration example of the hinge mechanism according to a modification of the present technology.

### MODE(S) FOR CARRYING OUT THE INVENTION

Embodiments applied to an image-capturing apparatus of the present technology such as a camcorder, will now be described in detail with reference to the drawings.

### First Embodiment

### [Configuration of Image-Capturing Apparatus]

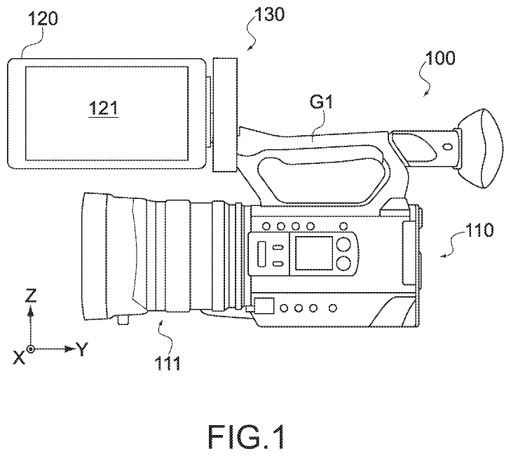

FIG. 1 illustrates a configuration example of an image-capturing apparatus 100 according to an embodiment of the present technology. Note that an X axis, a Y axis, and a Z axis represent three axial directions that are orthogonal to one another. Note that, as used herein, an X direction is defined as a “left-lateral direction”, a minus X direction is defined as a “right-lateral direction”, a Y direction is defined as an “optically axial rear direction”, a minus Y direction is defined as an “optically axial forward direction”, a Z direction is defined as an “upward direction”, and a minus Z direction is defined as a “downward direction”.

The image-capturing apparatus 100 includes a main body 110, a display unit 120, and a hinge mechanism 130. The main body 110 includes an imaging optical system 111, a grip G1, and a grip belt G2.

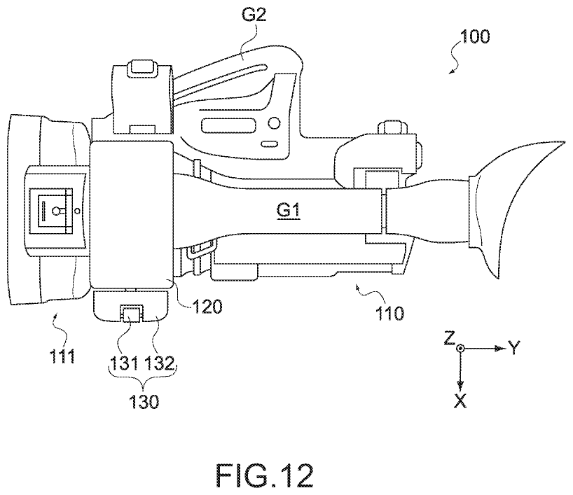

The grip G1 is formed to extend in a Y-axis direction on an upward side of the main body 110, and includes, on its optically axial forward side, a support portion that supports the display unit 120. The grip belt G2 is provided on a right-lateral side of the main body 110 (refer to FIG. 12). The grip G1 and the grip belt G2 serve as a handle of the image-capturing apparatus 100.

The display unit 120 includes a display screen 121. The display screen 121 is integrally provided with a manipulation unit 120a described later. The orientation of the display screen 121 of the display unit 120 is changeable, and the display unit 120 is, for example, an LCD (Liquid Crystal Display) or an organic EL (Electro Luminescence) panel that is rotatably connected to the main body 110 through the hinge mechanism 130.

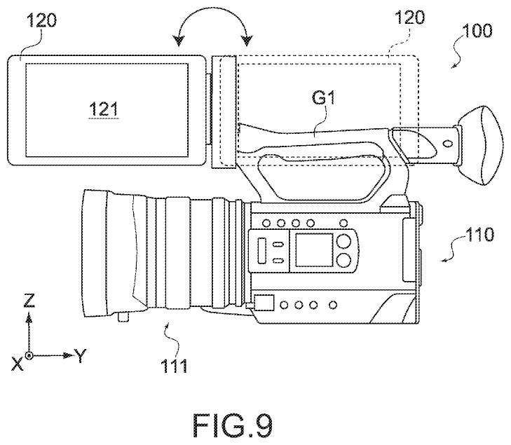

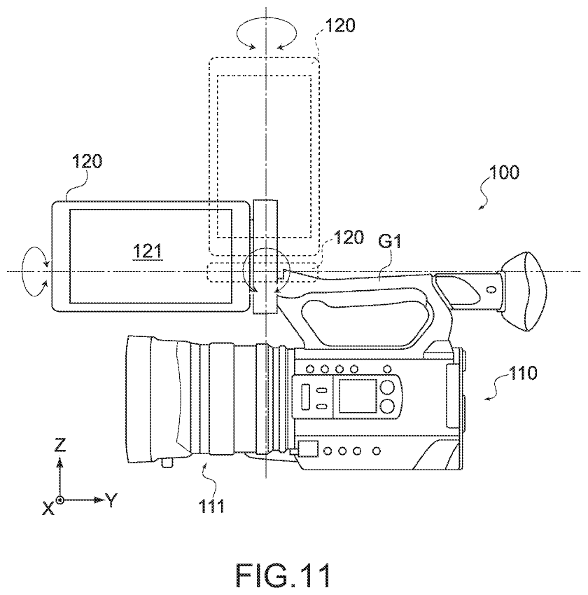

The display unit 120 is placed higher than the imaging optical system 111 in a Z direction on an optically axial forward side of the main body 110, and is coupled to the main body 110 (the support portion of the grip G1) through the hinge mechanism 130. Accordingly, the display unit 120 according to the present embodiment is configured rotatably about an X axis, a Y axis (optical axis), and a Z axis with respect to the main body 110 (refer to FIG. 11). Such a configuration is achieved by the configuration of the hinge mechanism 130 that couples the display unit 120 to the main body 110. Note that, in FIG. 1, as well as FIGS. 9 to 12, 14, and 20 subsequent to FIG. 1, the description of the hinge mechanism 130 is simplified or omitted.

### [Hinge Mechanism]

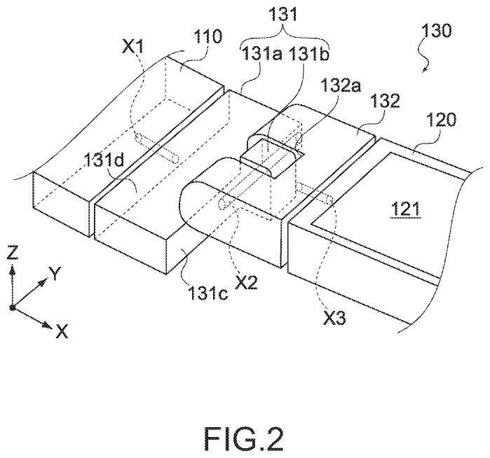

FIG. 2 is an enlarged schematic view illustrating a portion around the hinge mechanism 130 in the image-capturing apparatus 100, and is a perspective view of the hinge mechanism 130.

As illustrated in FIG. 2, the hinge mechanism 130 includes a first rotational shaft X1, a second rotational shaft X2, a third rotational shaft X3, a first coupling portion 131, and a second coupling portion 132. The first rotational shaft X1 is a rotational shaft parallel to the X axis, and the second rotational shaft X2 is a rotational shaft orthogonal to the X axis. Further, the third rotational shaft X3 is a rotational shaft orthogonal to the Y axis.

A detailed configuration of the hinge mechanism 130 is described below, using an example in which the first to third rotational shafts X1, X2, and X3 are respectively parallel to the X axis, the Y axis, and the Z axis.

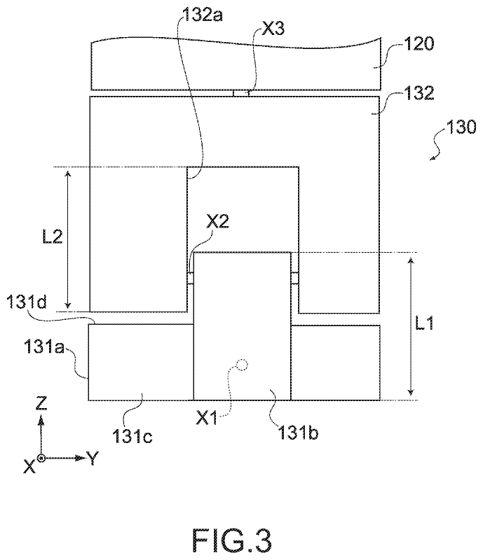

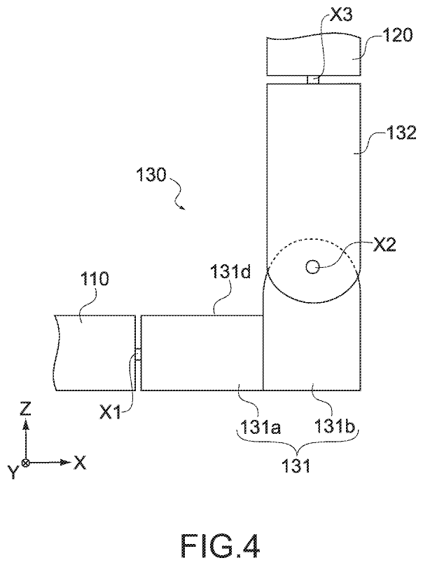

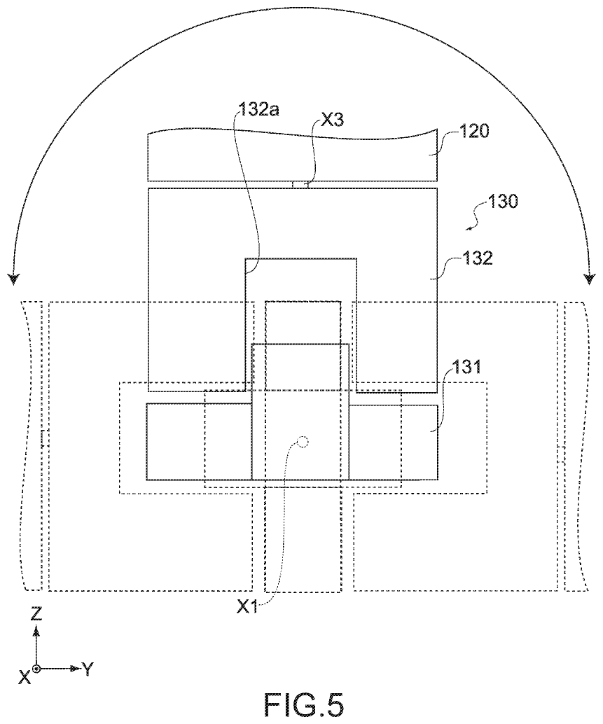

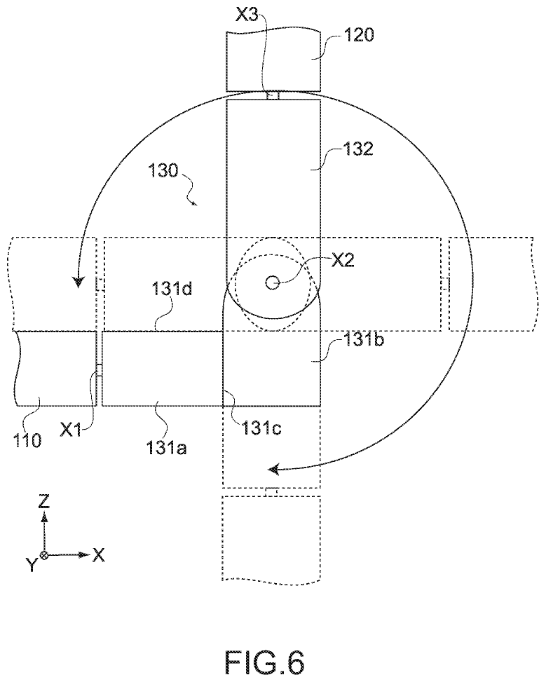

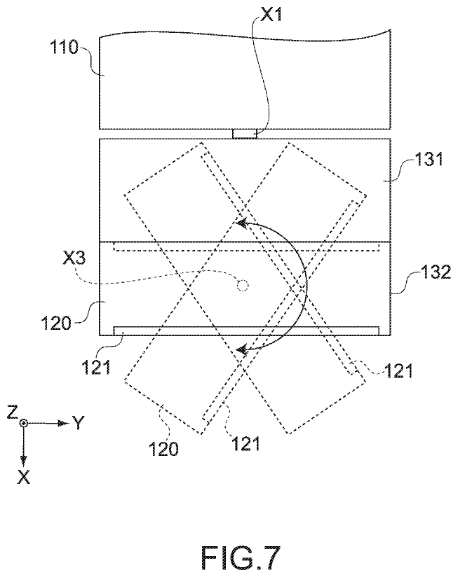

FIGS. 3 and 4 are enlarged schematic views illustrating the hinge mechanism 13, where FIG. 3 is a front view and FIG. 4 is a side view. Further, FIGS. 5 and 6 are schematic views respectively illustrating rotational ranges of the coupling portions 131 and 132 constituting the hinge mechanism 130, and FIG. 7 is a schematic view illustrating a rotational range of the display unit 12.

The first coupling portion 131 is constituted of a plate-like portion 131a and a protrusion portion 131b. The plate-like portion 131a is supported by the main body 110 through the first rotational shaft X1. The protrusion portion 131b is provided in the center of a left-lateral side 131c of the plate-like portion 131a in the Y-axis direction, and protrudes upwardly above an upward principal side 131d. As illustrated in FIG. 5, the first coupling portion 131 has a rotational range in which the first coupling portion 131 rotates at least 180 degrees about the first rotational shaft X1 with respect to the main body 110.

The second coupling portion 132 is a U-shaped plate-like portion, and has an opening 132a that opens toward the protrusion portion 131b. The second coupling portion 132 is supported by an upward end of the protrusion portion 131b through the second rotational shaft X2.

Here, in FIG. 3, in the second coupling portion 132 according to the present embodiment, a width L2 of the opening 132a in the Z-axis direction is substantially equal to or greater than a height L1 of the protrusion portion 131b in the Z-axis direction, and the second rotational shaft X2 is skew to the first rotational shaft X1. As illustrated in FIG. 6, this configuration permits the second coupling portion 132 to have a rotational range in which the second coupling portion 132 rotates 270 degrees about the second rotational shaft X2. This results in being able to accommodate the display screen 121 of the display unit 120 in a state of being oriented in the left-lateral direction. Typically, the second coupling portion 132 is fixed with click at 90-degree intervals during a period from the second coupling portion 132 being in contact with the principal side 131d to the second coupling portion 132 coming into contact with the side 131c.

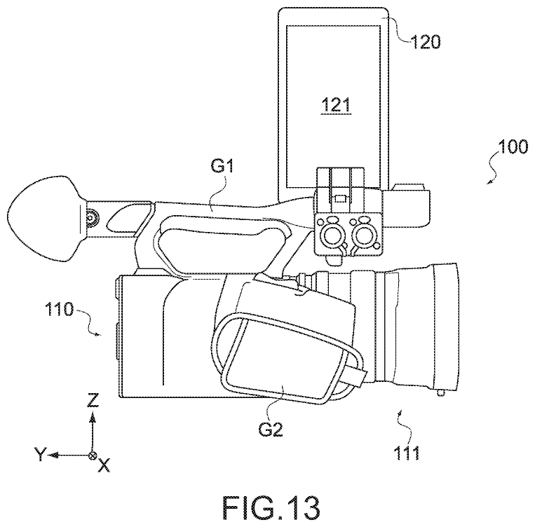

Further, the second coupling portion 132 supports the display unit 120 through the third rotational shaft X3. As illustrated in FIG. 7, the display unit 120 has a rotational range in which the display unit 120 rotates at least 180 degrees about the third rotational shaft X3 with respect to the second coupling portion 132. This results in being able to invert the display unit 120, for example, from a state in which the display screen 121 is oriented toward the grip belt G2 (refer to FIG. 13). In other words, it is possible to invert the display screen 121 from a state of being oriented in the left-lateral direction to a state of being oriented in the right-lateral direction.

Furthermore, in the hinge mechanism 130, the first and second coupling portions 131 and 132 have different strengths of movement. Specifically, the first coupling portion 131 rotates about the first rotational shaft X1 with respect to the main body 110 with a torque (a rotative force) not less than a first torque value, and the second coupling portion 132 rotates about the second rotational shaft X2 with respect to the first coupling portion 131 with a torque not less than a second torque value that is less than the first torque value. Moreover, the display unit 120 rotates about the third rotational shaft X3 with respect to the second coupling portion 132 with a torque not less than a third torque value that is less than the second torque value.

In other words, in the hinge mechanism 130, the torque values with which the first coupling portion 131, the second coupling portion 132, and the display unit 120 are respectively rotated, are smaller in the order of the first torque value, the second torque value, and the third torque value. Thus, the highest priority is given to the rotation of the display unit 120 about the third rotational shaft X3, and the rotation of the second coupling portion 132 about the second rotational shaft X2 is given priority over the rotation of the first coupling portion 131 about the first rotational shaft X1. This results in preventing an erroneous manipulation upon rotating the display unit 120, and in improving handling capability of the image-capturing apparatus 100.

The first to third torque values are not particularly limited, but, for example, the first torque value is about 1.2N·m, and the second torque value is about 0.5N·m. Further, the third torque value may be a torque value less than 0.5N·m. Furthermore, the material constituting the hinge mechanism 130 is also not particularly limited, and any type of material such as a synthetic resin and a metal material may be used.

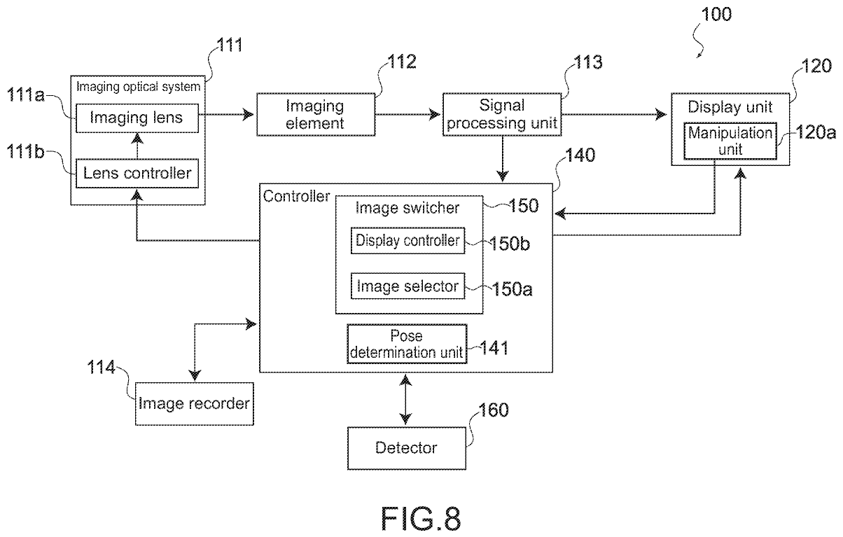

In addition, the hinge mechanism 130 is provided with a detector 160 described later (refer to FIG. 8). This permits the image-capturing apparatus 100 to detect a pose of the display unit 120 relative to the main body 110. For example, the configuration and the arrangement of the detector 160 provided in the hinge mechanism 130 will be described later.

FIG. 8 is a block diagram of the configuration example of the image-capturing apparatus 100. The image-capturing apparatus 100 includes an imaging optical system 111, an imaging element 112, a signal processing unit 113, an image recorder 114, the detector 160, a controller 140, and a manipulation unit 120a.

The imaging optical system 111 includes an imaging lens 111a and a lens controller 111b. The imaging lens 111a collects light from a subject onto the imaging element 112. The lens controller 111b is constituted of, for example, a drive mechanism used for moving the imaging lens 111a to perform focusing and zooming, and an encoder that detects a focus position and a zoom position of the imaging lens 111a. They are driven according to a control signal from the controller 140. An image of a subject that is obtained through the imaging optical system 111 is combined on the imaging element 112 serving as an imaging device.

The imaging element 112 is an image sensor constituted of, for example, a CD (Charge Coupled Device) or a CMOS (Complementary MOS) that converts a subject light from a subject into an electric signal. The imaging element 112 may be an image sensor of a rear-side-irradiating type or a stacking-type image sensor obtained by stacking a pixel portion and a logic portion.

The signal processing unit 113 performs a specified process, such as an A/D conversion process, a pixel interpolation process, and a correction process, on an image output from the imaging element 112, and outputs the processed image to the display unit 120 and controller 140. Accordingly, a through image (hereinafter referred to as a first image S1) is displayed on the display screen 121 of the display unit 120.

The image recorder 114 is a semiconductor memory constituted of a volatile memory such as DRAM (Dynamic Random Access Memory), and stores therein an image on which a specified process has been performed by the signal processing unit 113. In addition to the image described above, the image recorder 114 according to the present embodiment stores therein, for example, a recorded image P4 and an enlarged image P3 (magnified image) as well as a set image P1 and a focus-assist image P2 as a selection image P.

The detector 160 is capable of detecting each pose of the display unit 120, and is provided in the hinge mechanism 13. The detector 160 according to the present embodiment is constituted of, for example, a Hall element and a magnet corresponding to the Hall element in pairs. In the present embodiment, plural detectors 160 each constituted of a pair of the Hall element and the magnet are placed at appropriate positions around the rotational shafts X1 to X3 and of the coupling portions 131 and 132.

The Hall element detects the change of a magnetic field according to the change of a pose of the display unit 120, and produces a current. The strength of a magnet force created by the magnet is measured by the Hall element, and a result of the measurement is output to the controller 140. The controller 140 can determine each pose of the display unit 120 using the change of a magnetic force to which the Hall element is subjected from the magnet.

Note that the detector 160 according to the present embodiment is typically constituted of a Hall element and a magnet, and is not particularly limited if it can detect each pose of the display unit 120. Any type of detector such as an acceleration sensor, an infrared sensor, and a PSD (Position Sensitive Detector) sensor may be used.

The controller 140 is constituted of, for example, CPU, RAM, and ROM. The ROM stores therein, for example, a program that is read by the CPU to be operated. The RAM is used as work memory of the CPU. The CPU performs various processes in accordance with the program stored in the ROM so as to control the entire image-capturing apparatus 100.

Further, the controller 140 includes a pose determination unit 141 and an image switcher 150. According to a result of measurement performed by the detector 160, the pose determination unit 141 determines a pose of the display unit 120 relative to the main body 110, and outputs a result of the determination to the image switcher 150.

The image switcher 150 includes an image selector 150a and a display controller 150b. According to the result of the determination performed by the pose determination unit 141, the image selector 150a selects an image suitable for the pose of the display unit 120 from selection images P recorded in the image recorder 114, and outputs the selected selection image P to the display controller 150b. Here, for example, a selection image P selected by the image selector 150a is a selection image that is used most frequently in each pose of the display unit 120.

The display controller 150b displays the selection image P output from the image selector 150a on a specified position of the display screen 121. In other words, the display controller 150b displays, on the display screen 121, a first image S1 captured by the imaging optical system 111 and the selection image P selected by the image selector 150a. Accordingly, the first image S1 displayed on the display screen 121 is switched to a second image S2 including the first image S1 and the selection image P.

The manipulation unit 120a is constituted of, for example, a touch panel configured integrally with the display screen 121 of the display unit 120. Accordingly, when a photographer manipulates the manipulation unit 120a, the controller 140 controls a functional block according to the present embodiment depending on the manipulation performed by the photographer.

For example, a photographer performs, by manipulating the manipulation unit 120a, a desired process such as the change of a selection image P displayed on the display screen 121, the process regarding a display direction of first and second images S1 and S2, and focus adjustment or image-quality adjustment. Note that, in the present embodiment, for example, a power button for switching power ON/OFF, a release button for supporting the start of recording a captured image, and an operator for zoom adjustment may be included as examples of the manipulation unit 120a.

### [Operation of and Control Example of Image-Capturing Apparatus]

FIGS. 9 to 11 illustrate operations of the display unit 120 in the image-capturing apparatus 100, and FIGS. 12 to 14 illustrate respective poses of the display unit 120 in the image-capturing apparatus 100.

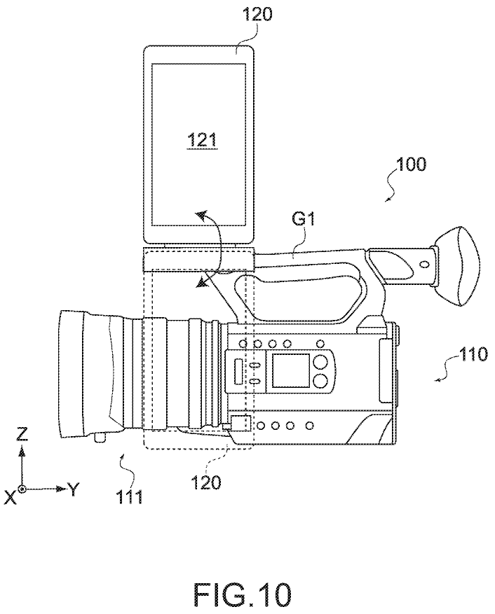

In the image-capturing apparatus 100 according to the present embodiment, the display unit 120 is supported by the main body 110 through the hinge mechanism 130. This permits the display unit 120 to rotate in the Y-axis direction (in the optical axis direction) with respect to the main body 110 as illustrated in FIG. 9, to rotate in the X-axis direction (about the optical axis) with respect to the main body 110 as illustrated in FIG. 10, and to rotate about the X, Y, and Z axes with respect to the main body 110 as illustrated in FIG. 11.

Operations of the image-capturing apparatus 100 before the display unit 120 changes its pose to poses illustrated in FIGS. 1, 13, and 14 from among poses that may be made by the display unit 120, and control examples after the display unit 120 changes its pose to these poses are described below.

### Application Example 1

FIG. 12 is a plan view of the image-capturing apparatus 100, and illustrates an initial pose (home position) of the display unit 120. In this pose, the display screen 121 of the display unit 120 faces the main body 110 in the Z-axis direction.

First, in a state in which the display unit 120 is in the initial pose illustrated in FIG. 12, the second coupling portion 132 is rotated 90 degrees about the second rotational shaft X2. Then, the display unit 120 is rotated 180 degrees about the third rotational shaft X3 (inverted), and the first coupling portion 131 is rotated 90 degrees about the first rotational shaft X1 toward the imaging optical system 111. Accordingly, the display unit 120 changes its pose from the initial pose to a pose in which the first rotational shaft X1 to the third rotational shaft X3 are respectively parallel to the X axis, the Z axis, and the Y axis (hereinafter referred to as a lateral pose), as illustrated in FIG. 1.

Here, according to a result of measurement performed by the detector 160, the pose determination unit 141 determines that the display unit 120 is in the lateral pose, and outputs a result of the determination to the image selector 150a. In response to the result of the determination performed by the pose determination unit 141, the image selector 150a selects an image suitable for the lateral pose from among selection images P recorded in the image recorder 114. Then, the image selected by the image selector 150a is output to the display unit 120 through the display controller 150b, and a second image S2 including a first image S1 and a selection image P is displayed on the display unit 120.

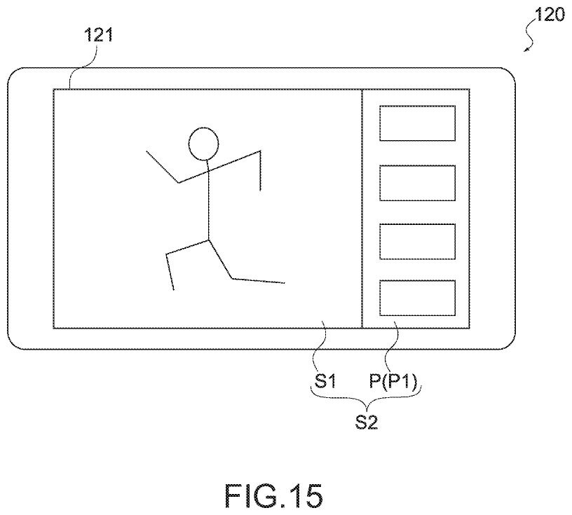

FIGS. 15 to 19 illustrate variations of the second image S2. For example, when the image selector 150a selects a set image P1 as a selection image P, a first image S1 captured by the imaging optical system 111 and the set image P1 are displayed on the display screen 121, as illustrated in FIG. 15. The set image P1 can be directly manipulated using, for example, a touch panel.

This permits a photographer to check an image displayed on the display screen 121 from the left-lateral direction of the main body 110, and to set the image-capturing apparatus 100. In other words, a second image S2 suitable for a photographer in the left-lateral direction of the main body 110 is displayed on the display screen 121. Note that, in the present embodiment, when the display unit 120 is in the lateral pose, only a first image S1 may be displayed on the display screen 121, or, for example, a division line or a safety area may be displayed together with the first image S1.

### Application Example 2

In a state in which the display unit 120 is in the initial pose illustrated in FIG. 12, the second coupling portion 132 is rotated 90 degrees about the second rotational shaft X2. Accordingly, the display unit 120 changes its pose from the initial pose to a pose in which the first rotational shaft X1 to the third rotational shaft X3 are respectively parallel to the X axis, the Y axis, and the Z axis (hereinafter referred to as a first longitudinal pose), as illustrated in FIG. 13.

When the display unit 120 changes its pose to the first longitudinal pose, the image selector 150a selects a selection image P suitable for the first longitudinal pose by performing the same control as in Application Example 1.

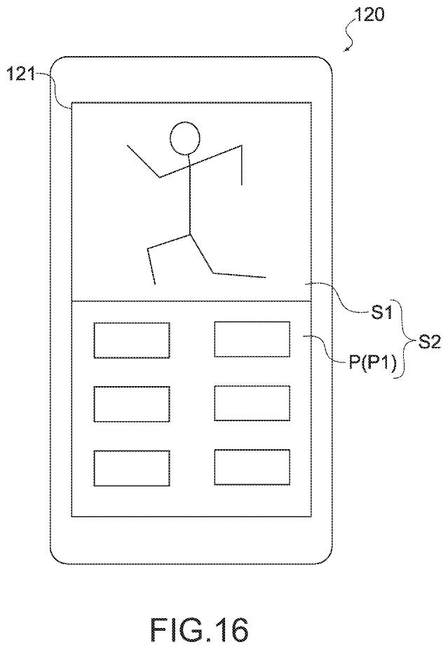

For example, when the image selector 150a selects a set image P1 as a selection image P, a first image S1 captured by the imaging optical system 111 and the set image P1 are displayed on the display screen 121, as illustrated in FIG. 16. This permits a photographer to check an image displayed on the display screen 121 from the side of the grip belt G2 (the right-lateral direction) of the image-capturing apparatus 100, and to set the image-capturing apparatus 100. Further, since the first image S1 and the set image P1 are separately displayed on the display screen 121, visibility upon checking the first image S1 is improved, compared to when the first image S1 is superimposed on the set image P1.

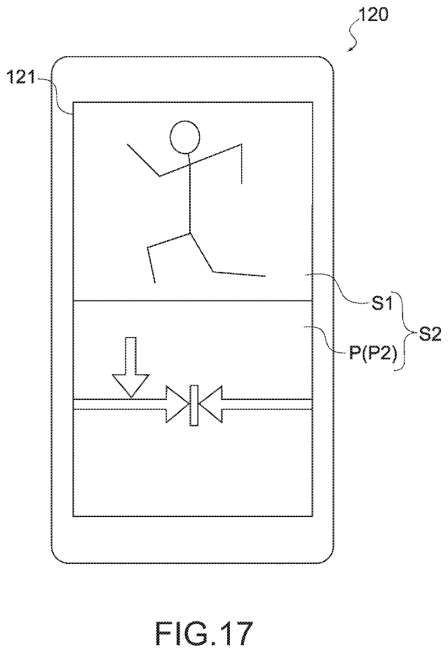

Further, when the image selector 150a selects a focus-assist image P2 as a selection image P, the first image S1 and the focus-assist image P2 are displayed as a so-called OSD (On Screen Display) image on the display screen 121, as illustrated in FIG. 17. This results in being able to perform focus adjustment on the imaging optical system 111 while checking the first image S1 from the side of the grip belt G2 of the image-capturing apparatus 100.

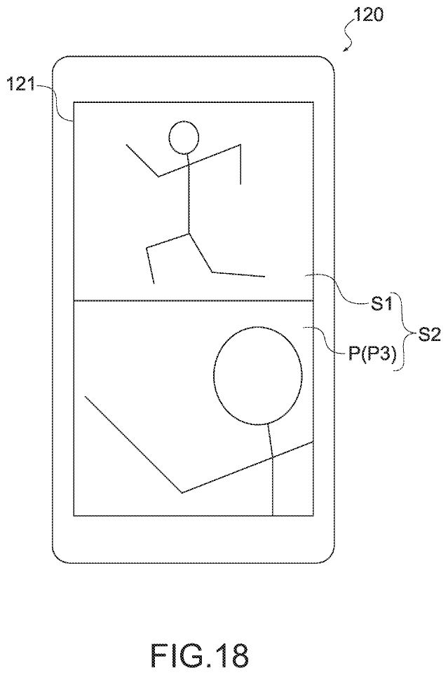

In particular, when the image selector 150a selects an enlarged image P3 (magnified image) as a selection image P, the first image S1 and the enlarged image P3 are displayed on the display screen 121, as illustrated in FIG. 18, which results in being able to perform focus adjustment on the imaging optical system 111 more easily.

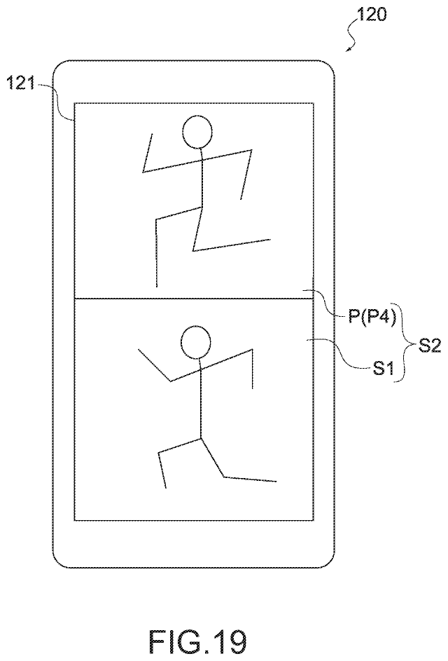

In addition, when the image selector 150a selects a recorded image P4 as a selection image P, a two-screen image constituted of the first image S1 and the recorded image P4 is displayed on the display screen 121, as illustrated in FIG. 19. This results in being able to check the first image S1 while comparing the first image S1 with the recorded image P4, from the side of the grip belt G2 of the image-capturing apparatus 100.

### Application Example 3

First, in a state in which the display unit 120 is in the initial pose illustrated in FIG. 12, the second coupling portion 132 is rotated 90 degrees about the second rotational shaft X2. Then, the display unit 120 is rotated 90 degrees clockwise about the third rotational shaft X3, and the first coupling portion 131 is rotated counterclockwise by a specified angle about the first rotational shaft X1.

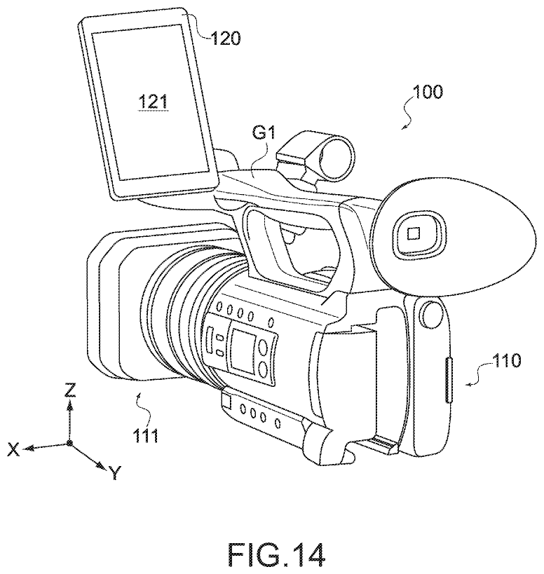

Accordingly, the display unit 120 changes its pose from the initial pose to a state in which the display screen 121 is oriented in the optically axial rear direction and in which the second rotational shaft X2 and the third rotational shaft X3 are each inclined at a specified angle toward the imaging optical system 111 from a state in which the second rotational shaft X2 and the third rotational shaft X3 are respectively parallel to the Y axis and the Z axis (hereinafter referred to as a second longitudinal pose), as illustrated in FIG. 14.

When the display unit 120 changes its pose to the second longitudinal pose, the image selector 150a selects a selection image P suitable for the second longitudinal pose by performing the same control as in Application Example 1.

For example, when the image selector 150a selects a recorded image P4 as a selection image P, a two-screen image constituted of the first image S1 and the recorded image P4 is displayed, as illustrated in FIG. 19. This results in being able to check the first image S1 while comparing the first image S1 with the recorded image P4, from the optically axial rear direction of the image-capturing apparatus 100.

### [Effect of Image-Capturing Apparatus]

In recent years, the size of an imaging element mounted on an image-capturing apparatus such as a camcorder for business use, has increasingly become larger. The advantage of becoming larger is that, for example, it becomes possible to capture a video in which a background is blurred, which results in being able to perform image-capturing placing more importance on expression such as shooting a movie.

However, an image-capturing apparatus such as a conventional handy camcorder includes a small imaging element, captures an image (deep-focus image) that primarily comes into focus on a full screen, and is primarily used for media report.

On the other hand, due to the size of an imaging element becoming larger, such an image-capturing apparatus has been increasingly used for performing image-capturing placing importance on expression. Further, the number of pixels in a video has been recently increased by the image quality being developed from an HD (High Definition) image quality to a 4K image quality, and there has been a tendency for increased use for production.

Here, when capturing a video such as a movie in which importance is placed on expression, by use of the image-capturing apparatus described above, a primary use method is fixing it using a tripod. It is often the case that it is used by more than one person and that a photographer stands on the lateral side (in the right-lateral direction or the left-lateral direction) of a main body of the image-capturing apparatus.

However, an image-capturing apparatus such as a conventional camcorder is not produced on the assumption that it is used by more than one person, and it is sufficient if a photographer in the optically axial rear direction of the image-capturing apparatus can check an image displayed on a display unit. However, when the image-capturing apparatus described above is used by more than one person, for example, a photographer (cameraman) or an assistant photographer (assistant cameraman) is often on the lateral side of a main body of the image-capturing apparatus. Thus, there is a difficulty in checking a display screen in a range of motion of a display unit of the conventional image-capturing apparatus. Thus, in order to check a display screen from the lateral side of a main body of an image-capturing apparatus, there is a need to further mount an accompanying item such as a liquid crystal monitor, which may result in increasing the number of devices and in a cost increase due to the increase in the number of devices.

In order to solve such a problem, in the image-capturing apparatus 100 according to the present embodiment, the display unit 120 is configured rotatably about three axes orthogonal to one another, as illustrated in FIG. 11, which results in significantly improving a range of motion of the display unit 120, compared to conventional image-capturing apparatuses.

Accordingly, a photographer can check an image displayed on the display screen 121 not only from the optically axial rear direction of the image-capturing apparatus 100 but also from all of the directions. Thus, the increase in the number of devices and the cost increase described above are prevented.

Further, in the image-capturing apparatus 100, according to the change of a pose of the display unit 120, the image displayed on the display screen 121 is switched to an image suitable for a respective pose of the display unit 120. This eliminates the inconvenience of changing an image displayed on display screen 121 every time the pose of the display unit 120 is changed, and provides a configuration more suitable for being used by more than one person.

Thus, the image-capturing apparatus 100 according to the present embodiment is favorably used as an apparatus that captures a video in which more importance is placed on expression, by a plurality of photographers proceeding with different tasks at the same time using a single image-capturing apparatus.

### Second Embodiment

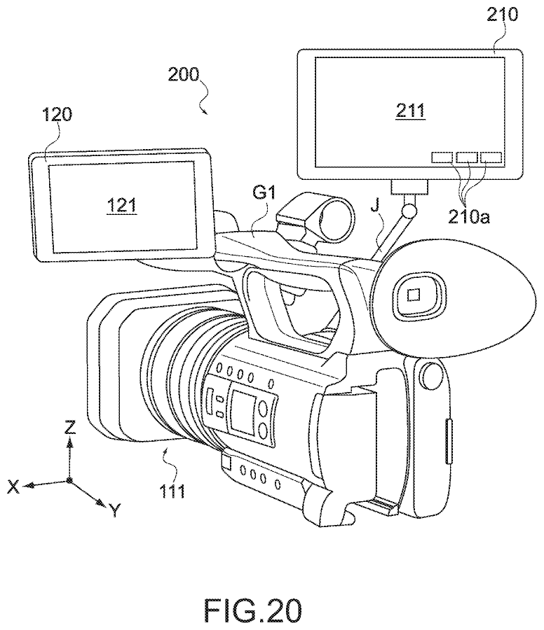

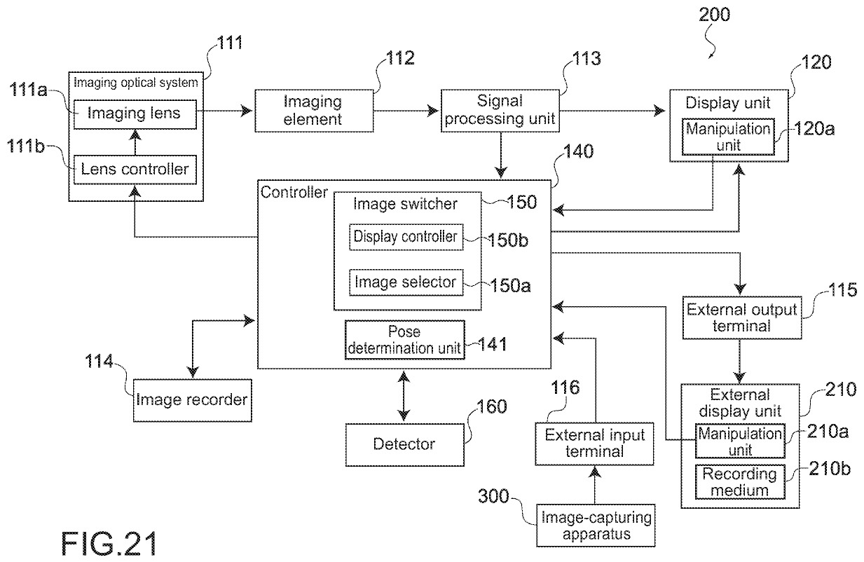

FIG. 20 illustrates a configuration example of an image-capturing apparatus 200 according to a second embodiment of the present technology, and FIG. 21 is a block diagram of the configuration example of the image-capturing apparatus 200. A component similar to that in the first embodiment is denoted by the same reference symbol below, and a detailed description thereof is omitted or simplified.

The image-capturing apparatus 200 according to the present embodiment has in common with the image-capturing apparatus according to the first embodiment in including the main body 110, the display unit 120, and the hinge mechanism 130, and is different from the image-capturing apparatus according to the first embodiment in including an external display unit 210.

The external display unit 210 is connected to an external output terminal 115 of the image-capturing apparatus 100 via a wire. The external display unit 210 is, for example, an LCD or an organic panel connected to the main body 110 through a coupling portion J on the right-lateral side of the main body 110. The orientation of the external display unit 210 according to the present embodiment is changeable with respect to the main body 110, and is configured rotatably about the Z axis as in the case of the display unit 210. This makes it possible to turn a display screen 211 of the external display unit 210 to the right-lateral direction, the left-lateral direction, the optically axial forward direction, and the optically axial rear direction.

The external display unit 210 includes the display screen 211, and the display screen 211 is provided with a manipulation unit 210a. The manipulation unit 210a is constituted of, for example, a touch panel configured integrally with the display screen 211. For example, a photographer can perform, by manipulating the manipulation unit 120a, a desired process such as focus adjustment or image-quality adjustment for first image S1 displayed on the display screens 121 and 211.

Further, the external display unit 210 includes a recording medium 210b as illustrated in FIG. 21. The recording medium 210b stores therein a first image S1 on which a specified process has been performed by the signal processing unit 113. The recording medium 210b is, for example, a recording medium such a memory card, and is constituted of, for example, a semiconductor memory or a magnetic disk.

### [Control Example of Image-Capturing Apparatus]

Next, regarding Application Examples 1 to 3 described in the first embodiment, control examples when using the external display unit 210 are described.

### Application Example 1

In Application Example 1 according to the first embodiment, when the display unit 120 changes its pose from the initial pose to the lateral pose, the first image S1 and the set image P1 are displayed on the display screen 121 of the display unit 120 (refer to FIG. 15), whereas, in Application Example 1 according to the second embodiment, the first image S1 is also displayed on the display screen 211 of the external display unit 210 in addition to being displayed on the display screen 121.

This permits a photographer to check the first image S1 displayed on the display screen 121 from the left-lateral direction of the main body 110, and permits another photographer to perform angle-of-view adjustment and focus adjustment on the first image S1 by manipulating the manipulation unit 210a. In other words, it becomes possible to proceed with checking the composition of the first image S1 and performing, for example, focus adjustment on the first image S1 at the same time.

### Application Example 2

In Application Example 2 according to the first embodiment, when the display unit 120 changes its pose from the initial pose to the first longitudinal pose, the first image S1, and, for example, the set image P1, the focus-assist image P2, the enlarged image P3, or the recorded image P4 are displayed on the display screen 121, whereas, in Application Example 2 according to the second embodiment, the first image S1 is also displayed on the display screen 211 in addition to being displayed on the display screen 121.

This permits a photographer to check the first image S1 using the display screen 121, and permits another photographer to perform angle-of-view adjustment and focus adjustment on the first image S1 through, for example, the set image P1 or the focus-assist image P2 displayed on the display screen 121.

Further, in the second embodiment, the image selector 150a is configured such that the image selector 150a not only selects an image recorded in the image recorder 114, but also can select, as a selection image P, an image (hereinafter referred to as a third image) input from a different image-capturing apparatus 300 through an external input terminal 116.

When the image selector 150a selects the third image as a selection image P, a two-screen image constituted of the first image S1 and the third image is displayed on the display screen 121 in the first longitudinal pose (refer to FIG. 19). Here, a tally light (not illustrated) blinks for an image of a primary apparatus. This makes it possible to check the first image S1 while comparing the first image S1 with the third image, which results in being able to operate a system camera that captures an image of a subject using a plurality of image-capturing apparatuses in combination.

### Application Example 3

In Application Example 3 according to the first embodiment, when the display unit 120 changes its pose from the initial pose to the second longitudinal pose, a two-screen image constituted of the first image S1 and the recorded image P4 is displayed on the display screen 121, whereas, in Application Example 3 according to the second embodiment, the first image S1 is also displayed on the display screen 211, and the image selector 150a selects a third image as a selection image P.

This permits a photographer to check the first image S1 using the external display unit 210, and permits another photographer to check the first image S1 while comparing the first image S1 with the third image on the display screen 121. In other words, it becomes possible to proceed with checking the composition of the first image S1 and comparing the first image S1 with the third image at the same time.

Although the embodiments of the present technology have been described above, it is needless to say that the present technology is not limited to only the embodiments described above and various modifications may be made.

For example, in the embodiments described above, the configuration of the hinge mechanism 130 has been described on the assumption that the rotational shafts X1, X2, and X3 are shafts respectively parallel to the X axis, the Y axis (optical axis), and the Z axis. However, the rotational shafts X1, X2, and X3 are not limited to this assumption, and other rotational shafts may be used as the rotational shafts X1, X2, and X3 if the display unit 120 is rotatable about three axes orthogonal to one another.

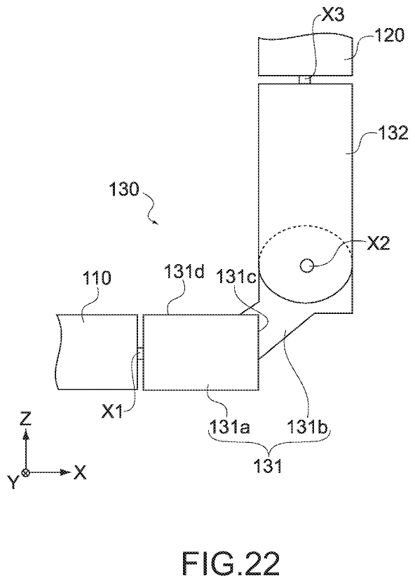

FIG. 22 illustrates a configuration example of the hinge mechanism 130 according to a modification of the present technology. In the embodiments described above, the protrusion portion 131d in the first coupling portion 131 is provided in the center of the left-lateral side 131c of the plate-like portion 131a in the Y-axis direction. However, the configuration is not limited to this.

For example, the protrusion portion 131d may be provided in the middle of a portion situated between the left-lateral side 131c and the upward principal side 131d of the plate-like portion 131a in the Y-axis direction, and may be configured to protrude, from the vicinity of a corner of the plate-like portion 131a formed by the intersection of the upward principal side 131d and the left-lateral side 131dc, in a direction of being inclined at a specified angle from the upper direction to the left-lateral direction, as illustrated in FIG. 22.

Further, in the embodiments described above, the first coupling portion 131 supported by the main body 110 is constituted of the plate-like portion 131a and the protrusion portion 131b, and the second coupling portion 132a supporting the display unit 120 is provided with the opening 132a. However, the configuration of the hinge mechanism 130 is not limited to this.

For example, in the hinge mechanism 130, the first coupling portion 131 supported by the main body 110 may be provided with an opening, and the second coupling portion 132 may be constituted of a protrusion portion accommodated in the opening and a plate-like portion supporting the display unit 120.

Further, in the hinge mechanism 130 of the embodiments described above, the first rotational shaft X1 and the second rotational shaft X2 are positioned to be skew to each other. However, the second rotational shaft X2 may be moved relative to the first rotational shaft X1, so that the first rotational shaft X1 and the second rotational shaft X2 are skew to each other.

In addition, in the embodiments described above, the second image S2 displayed on the display screen 121 of the display unit 120, is a two-screen image. However, it is not limited to this, and may be an image divided into three or more images.

Furthermore, in the embodiments described above, the pose of the display unit 120 is typically changed by hand, but the configuration is not limited to this. For example, a photographer may be detected with, for example, a motion detector, and the pose of the display unit 120 may be automatically changed following the detection using the motion detector.

In addition, in the embodiments described above, a camcorder has been described as an example of the image-capturing apparatus 100. However, the present technology is applicable to all of the image-capturing apparatuses whose display unit is coupled to the main body in a non-integrated manner.

Note that the present technology may also take the following configurations.
(1) An image-capturing apparatus including:

a main body that includes an imaging optical system;

a display unit that displays an image;

a hinge mechanism that couples the display unit to the main body and supports the display unit rotatably about a first axis, a second axis, and a third axis with respect to the main body, the second axis being orthogonal to the first axis, the third axis being orthogonal to the first and second axes;

a detector that detects a pose of the display unit; and

a controller that controls a display of an image on the display unit according to an output from the detector.
(2) The image-capturing apparatus according to (1), in which

the hinge mechanism includes
a first rotational shaft parallel to the first axis,
a second rotational shaft orthogonal to the first axis,
a third rotational shaft orthogonal to the second axis,
a first coupling portion supported by the main body through the first rotational shaft, and
a second coupling portion supported by the first coupling portion through the second rotational shaft, the second coupling portion supporting the display unit through the third rotational shaft.
(3) The image-capturing apparatus according to (2), in which

the first coupling portion rotates 180 degrees about the first rotational shaft with respect to the main body.
(4) The image-capturing apparatus according to (2) or (3), in which

the second rotational shaft is skew to the first rotational shaft.
(5) The image-capturing apparatus according to any one of (2) to (4), in which

the second coupling portion rotates 270 degrees about the second rotational shaft with respect to the first coupling portion.
(6) The image-capturing apparatus according to any one of (2) to (5), in which

the display unit rotates 180 degrees about the third rotational shaft with respect to the second coupling portion.
(7) The image-capturing apparatus according to any one of (2) to (6), in which

the first coupling portion is supported by the main body rotatably in an optical axis direction of the imaging optical system, and

the second coupling portion is supported by the first coupling portion rotatably about the optical axis.
(8) The image-capturing apparatus according to any one of (2) to (7), in which

the first coupling portion rotates about the first rotational shaft with a torque not less than a first torque value,

the second coupling portion rotates about the second rotational shaft with a torque not less than a second torque value that is less than the first torque value, and

the display unit rotates about the third rotational shaft with a torque not less than a third torque value that is less than the second torque value.
(9) The image-capturing apparatus according to any one of (1) to (8), in which the detector is provided in the hinge mechanism.
(10) The image-capturing apparatus according to any one of (1) to (9), in which

the controller includes
a pose determination unit that determines a pose of the display unit relative to the main body according to an output from the detector, and
an image switcher that switches, according to a result of the determination performed by the pose determination unit, an image displayed on the display unit from a first image captured by the imaging optical system to a second image different from the first image.
   (11) The image-capturing apparatus according to (10), in which

the pose determination unit detects, as a first longitudinal pose of the display unit, a state in which the first rotational shaft, the second rotational shaft, and the third rotational shaft are respectively parallel to the first axis, the second axis, and the third axis, and

the image switcher switches from the first image to a two-screen image when the display unit is in the first longitudinal pose.
(12) The image-capturing apparatus according to (10) or (11), in which

the pose determination unit detects, as a second longitudinal pose of the display unit, a state in which the second rotational shaft and the third rotational shaft are each inclined at a specified angle toward the imaging optical system from a state in which the second rotational shaft and the third rotational shaft are respectively parallel to the second axis and the third axis, and

the image switcher switches from the first image to a two-screen image when the display unit is in the second longitudinal pose.
(13) The image-capturing apparatus according to any one of (1) to (12), further including

an external display unit that includes a manipulation unit being capable of manipulating an image captured by the imaging optical system, the external display unit displaying the image.

### REFERENCE SIGNS LIST

100,200 image-capturing apparatus
110 main body
111 imaging optical system
120 display unit
120a,210a manipulation unit
130 hinge mechanism
131 first coupling portion
132 second coupling portion
140 controller
141 pose determination unit
150 image switcher
160 detector
210 external display unit
X1 first rotational shaft
X2 second rotational shaft
X3 third rotational shaft

1. An image-capturing apparatus comprising:
a main body that includes an imaging optical system;
a display unit that displays an image;
a hinge mechanism that couples the display unit to the main body and supports the display unit rotatably about a first axis, a second axis, and a third axis with respect to the main body, the second axis being orthogonal to the first axis, the third axis being orthogonal to the first and second axes;
a detector that detects a pose of the display unit; and
a controller that controls a display of an image on the display unit according to an output from the detector.

2. The image-capturing apparatus according to claim 1, wherein
the hinge mechanism includes
a first rotational shaft parallel to the first axis,
a second rotational shaft orthogonal to the first axis,
a third rotational shaft orthogonal to the second axis,
a first coupling portion supported by the main body through the first rotational shaft, and
a second coupling portion supported by the first coupling portion through the second rotational shaft, the second coupling portion supporting the display unit through the third rotational shaft.

3. The image-capturing apparatus according to claim 2, wherein
the first coupling portion rotates 180 degrees about the first rotational shaft with respect to the main body.

4. The image-capturing apparatus according to claim 2, wherein
the second rotational shaft is skew to the first rotational shaft.

5. The image-capturing apparatus according to claim 4, wherein
the second coupling portion rotates 270 degrees about the second rotational shaft with respect to the first coupling portion.

6. The image-capturing apparatus according to claim 2, wherein
the display unit rotates 180 degrees about the third rotational shaft with respect to the second coupling portion.

7. The image-capturing apparatus according to claim 2, wherein
the first coupling portion is supported by the main body rotatably in an optical axis direction of the imaging optical system, and
the second coupling portion is supported by the first coupling portion rotatably about the optical axis.

8. The image-capturing apparatus according to claim 2, wherein
the first coupling portion rotates about the first rotational shaft with a torque not less than a first torque value,
the second coupling portion rotates about the second rotational shaft with a torque not less than a second torque value that is less than the first torque value, and
the display unit rotates about the third rotational shaft with a torque not less than a third torque value that is less than the second torque value.

9. The image-capturing apparatus according to claim 1, wherein the detector is provided in the hinge mechanism.

10. The image-capturing apparatus according to claim 1, wherein
the controller includes
a pose determination unit that determines a pose of the display unit relative to the main body according to an output from the detector, and
an image switcher that switches, according to a result of the determination performed by the pose determination unit, an image displayed on the display unit from a first image captured by the imaging optical system to a second image different from the first image.

11. The image-capturing apparatus according to claim 10, wherein
the pose determination unit detects, as a first longitudinal pose of the display unit, a state in which the first rotational shaft, the second rotational shaft, and the third rotational shaft are respectively parallel to the first axis, the second axis, and the third axis, and
the image switcher switches from the first image to a two-screen image when the display unit is in the first longitudinal pose.

12. The image-capturing apparatus according to claim 10, wherein
the pose determination unit detects, as a second longitudinal pose of the display unit, a state in which the second rotational shaft and the third rotational shaft are each inclined at a specified angle toward the imaging optical system from a state in which the second rotational shaft and the third rotational shaft are respectively parallel to the second axis and the third axis, and
the image switcher switches from the first image to a two-screen image when the display unit is in the second longitudinal pose.

13. The image-capturing apparatus according to claim 1, further comprising
an external display unit that includes a manipulation unit being capable of manipulating an image captured by the imaging optical system, the external display unit displaying the image.
